(19) United States
(12) Patent Application Publication
(10) Pub. No.: US 2025/0280894 A1
(43) Pub. Date: Sep. 11, 2025

(54) AEROSOL GENERATING DEVICE

(71) Applicant: KT&G CORPORATION, Daejeon (KR)

(72) Inventors: Hyungjin JUNG, Seoul (KR); Taehun KIM, Yongin-si Gyeonggi-do (KR); Jueon PARK, Seoul (KR); Sungwook YOON, Suwon-si Gyeonggi-do (KR); Jungho HAN, Daejeon (KR)

(73) Assignee: KT&G CORPORATION, Daejeon (KR)

(21) Appl. No.: 18/858,981

(22) PCT Filed: Apr. 26, 2023
(86) PCT No.: PCT/KR2023/005696

§ 371 Date: Oct. 22, 2024

(30) Foreign Application Priority Data
May 2, 2022 (KR) 10-2022-0054345
May 13, 2022 (KR) 10-2022-0058742

(51) Int. Cl. A24F 40/57; A24F 40/10; A24F 40/20; A24F 40/30; A24F 40/46; A24F 40/51; H05B 1/02

(52) U.S. Cl. CPC A24F 40/57; A24F 40/10; A24F 40/20; A24F 40/30; A24F 40/46; A24F 40/51; H05B 1/02

(57) ABSTRACT

An aerosol-generating device is disclosed. The aerosol-generating device of the disclosure includes a battery, a temperature sensor configured to sense a temperature of the battery, a plurality of heaters, and a controller. The controller is configured to determine a threshold for a duty ratio corresponding to an output of the battery, based on the temperature of the battery, and adjust at least one of duty ratios corresponding to each of the plurality of heaters based on a total duty ratio corresponding to the plurality of heaters equal to or greater than the threshold.

### TECHNICAL FIELD

The present disclosure relates to an aerosol-generating device.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE OF INVENTION

### Technical Problem

It is an object of the present disclosure to solve the above and other problems.

It is another object of the present disclosure to provide an aerosol-generating device capable of ensuring stability of control for a heater and heating performance based on a temperature of a battery.

It is still another object of the present disclosure to provide an aerosol-generating device capable of ensuring stability of control for a heater and heating performance based on a voltage currently output from a battery.

It is still another object of the present disclosure to provide an aerosol-generating device capable of ensuring stability of control for a heater and heating performance based on a time power has been supplied from a battery.

### Solution to Problem

An aerosol-generating device according to an aspect of the present disclosure for accomplishing the above and other objects may include a battery, a temperature sensor configured to sense a temperature of the battery, a plurality of heaters, and a controller. The controller may determine a threshold for a duty ratio corresponding to an output of the battery, based on the temperature of the battery, and adjust at least one of duty ratios corresponding to each of the plurality of heaters based on a total duty ratio corresponding to the plurality of heaters equal to or greater than the threshold.

An aerosol-generating device according to an aspect of the present disclosure for accomplishing the above and other objects may include a battery, a temperature sensor configured to sense a temperature of the battery, a heater, and a controller. The controller may determine a threshold for a duty ratio corresponding to an output of the battery, based on the temperature of the battery, and adjust a duty ratio corresponding to the heater based on the duty ratio corresponding to the heater equal to or greater than the threshold.

### Advantageous Effects of Invention

According to at least one of embodiments of the present disclosure, it may be possible to ensure stability of control for a heater and heating performance based on a voltage currently output from a battery.

According to at least one of embodiments of the present disclosure, it may be possible to ensure stability of control for a heater and heating performance based on a voltage currently output from a battery.

According to at least one of embodiments of the present disclosure, it may be possible to ensure stability of control for a heater and heating performance based on based on a time power has been supplied from a battery.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

The above and other objects, features and other advantages of the present disclosure will be more clearly understood from the following detailed description taken in conjunction with the accompanying drawings, in which:

FIG. 1 is a block diagram of an aerosol-generating device according to an embodiment of the present disclosure;

FIGS. 2 to 4 are views for explaining an aerosol-generating device according to embodiments of the present disclosure;

FIGS. 5 and 6 are views for explaining a stick according to embodiments of the present disclosure;

FIGS. 7 and 8 are flowcharts showing an operation method of the aerosol-generating device according to an embodiment of the present disclosure; and

FIGS. 9 to 15 are diagrams for explaining the operation of an aerosol-generating device according to an embodiment of the present disclosure.

### MODE FOR THE INVENTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description. The “module” and “unit” are do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that the terms “first”, “second”, etc., may be used herein to describe various components. However, these components should not be limited by these terms. These terms are only used to distinguish one component from another component.

It will be understood that when a component is referred to as being “connected to” or “coupled to” another component, it may be directly connected to or coupled to another component. However, it will be understood that intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

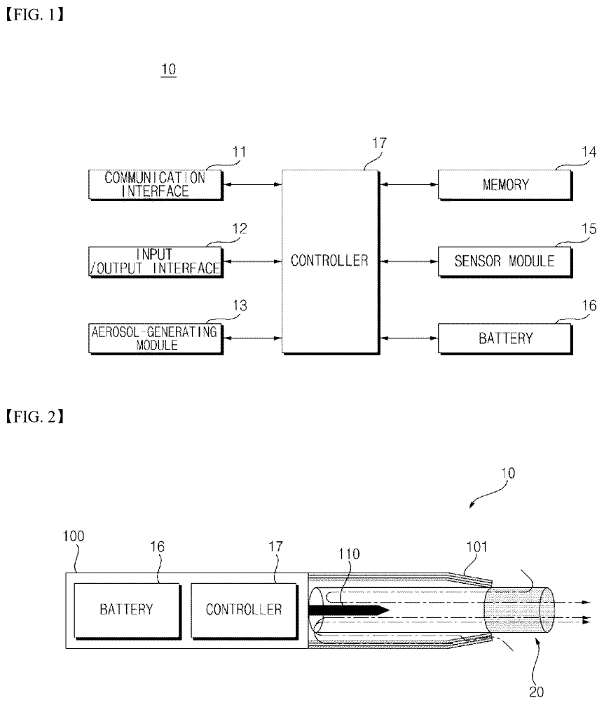

FIG. 1 is a block diagram of an aerosol-generating device according to an embodiment of the present disclosure.

Referring to FIG. 1, an aerosol-generating device 10 may include a communication interface 11, an input/output interface 12, an aerosol-generating module 13, a memory 14, a sensor module 15, a battery 16, and/or a controller 17.

In one embodiment, the aerosol-generating device 10 may be composed only of a main body. In this case, components included in the aerosol-generating device 10 may be located in the main body. In another embodiment, the aerosol-generating device 10 may be composed of a cartridge, which contains an aerosol-generating substance, and a main body. In this case, the components included in the aerosol-generating device 10 may be located in at least one of the main body or the cartridge.

The communication interface 11 may include at least one communication module for communication with an external device and/or a network. For example, the communication interface 11 may include a communication module for wired communication, such as a Universal Serial Bus (USB). For example, the communication interface 11 may include a communication module for wireless communication, such as Wireless Fidelity (Wi-Fi), Bluetooth, Bluetooth Low Energy (BLE), ZigBee, or nearfield communication (NFC).

The input/output interface 12 may include an input device (not shown) for receiving a command from a user and/or an output device (not shown) for outputting information to the user. For example, the input device may include a touch panel, a physical button, a microphone, or the like. For example, the output device may include a display device for outputting visual information, such as a display or a light-emitting diode (LED), an audio device for outputting auditory information, such as a speaker or a buzzer, a motor for outputting tactile information such as haptic effect, or the like.

The input/output interface 12 may transmit data corresponding to a command input by the user through the input device to another component (or other components) of the aerosol-generating device 100. The input/output interface 12 may output information corresponding to data received from another component (or other components) of the aerosol-generating device 10 through the output device.

The aerosol-generating module 13 may generate an aerosol from an aerosol-generating substance. Here, the aerosol-generating substance may be a substance in a liquid state, a solid state, or a gel state, which is capable of generating an aerosol, or a combination of two or more aerosol-generating substances.

According to an embodiment, the liquid aerosol-generating substance may be a liquid including a tobacco-containing material having a volatile tobacco flavor component. According to another embodiment, the liquid aerosol-generating substance may be a liquid including a non-tobacco material. For example, the liquid aerosol-generating substance may include water, solvents, nicotine, plant extracts, flavorings, flavoring agents, vitamin mixtures, etc.

The solid aerosol-generating substance may include a solid material based on a tobacco raw material such as a reconstituted tobacco sheet, shredded tobacco, or granulated tobacco. In addition, the solid aerosol-generating substance may include a solid material having a taste control agent and a flavoring material. For example, the taste control agent may include calcium carbonate, sodium bicarbonate, calcium oxide, etc. For example, the flavoring material may include a natural material such as herbal granules, or may include a material such as silica, zeolite, or dextrin, which includes an aroma ingredient.

In addition, the aerosol-generating substance may further include an aerosol-forming agent such as glycerin or propylene glycol.

The aerosol-generating module 13 may include at least one heater (not shown).

The aerosol-generating module 13 may include an electro-resistive heater. For example, the electro-resistive heater may include at least one electrically conductive track. The electro-resistive heater may be heated as current flows through the electrically conductive track. At this time, the aerosol-generating substance may be heated by the heated electro-resistive heater.

The electrically conductive track may include an electro-resistive material. In one example, the electrically conductive track may be formed of a metal material. In another example, the electrically conductive track may be formed of a ceramic material, carbon, a metal alloy, or a composite of a ceramic material and metal.

The electro-resistive heater may include an electrically conductive track that is formed in any of various shapes. For example, the electrically conductive track may be formed in any one of a tubular shape, a plate shape, a needle shape, a rod shape, and a coil shape.

The aerosol-generating module 13 may include a heater that uses an induction-heating method. For example, the induction heater may include an electrically conductive coil. The induction heater may generate an alternating magnetic field, which periodically changes in direction, by adjusting the current flowing through the electrically conductive coil. At this time, when the alternating magnetic field is applied to a magnetic body, energy loss may occur in the magnetic body due to eddy current loss and hysteresis loss. In addition, the lost energy may be released as thermal energy. Accordingly, the aerosol-generating substance located adjacent to the magnetic body may be heated. Here, an object that generates heat due to the magnetic field may be referred to as a susceptor.

Meanwhile, the aerosol-generating module 13 may generate ultrasonic vibrations to thereby generate an aerosol from the aerosol-generating substance.

The aerosol-generating device 10 may be referred to as a cartomizer, an atomizer, or a vaporizer.

The memory 14 may store programs for processing and controlling each signal in the controller 17. The memory 14 may store processed data and data to be processed.

For example, the memory 14 may store applications designed for the purpose of performing various tasks that can be processed by the controller 17. The memory 14 may selectively provide some of the stored applications in response to the request from the controller 17.

For example, the memory 14 may store data on the operation time of the aerosol-generating device 100, the maximum number of puffs, the current number of puffs, the number of uses of battery 16, at least one temperature profile, the user's inhalation pattern, and data about charging/discharging. Here, “puff” means inhalation by the user. “inhalation” means the user's act of taking air or other substances into the user's oral cavity, nasal cavity, or lungs through the user's mouth or nose.

The memory 14 may include at least one of volatile memory (e.g. dynamic random access memory (DRAM), static random access memory (SRAM), or synchronous dynamic random access memory (SDRAM)), nonvolatile memory (e.g. flash memory), a hard disk drive (HDD), or a solid-state drive (SSD).

The sensor module 15 may include at least one sensor.

For example, the sensor module 15 may include a sensor for sensing a puff (hereinafter referred to as a “puff sensor”). In this case, the puff sensor may be implemented as a proximity sensor such as an IR sensor, a pressure sensor, a gyro sensor, an acceleration sensor, a magnetic field sensor, or the like.

For example, the sensor module 15 may include a sensor for sensing a puff (hereinafter referred to as a “puff sensor”). In this case, the puff sensor may be implemented by a pressure sensor, a gyro sensor, an acceleration sensor, a magnetic field sensor, or the like.

For example, the sensor module 15 may include a sensor for sensing the temperature of the heater included in the aerosol-generating module 13 and the temperature of the aerosol-generating substance (hereinafter referred to as a “temperature sensor”). In this case, the heater included in the aerosol-generating module 13 may also serve as the temperature sensor. For example, the electro-resistive material of the heater may be a material having a predetermined temperature coefficient of resistance. The sensor module 15 may measure the resistance of the heater, which varies according to the temperature, to thereby sense the temperature of the heater.

For example, in the case in which the main body of the aerosol-generating device 10 is formed to allow a stick to be inserted thereinto, the sensor module 15 may include a sensor for sensing insertion of the stick (hereinafter referred to as a “stick detection sensor”).

For example, in the case in which the aerosol-generating device 10 includes a cartridge, the sensor module 15 may include a sensor for sensing mounting/demounting of the cartridge and the position of the cartridge (hereinafter referred to as a “cartridge detection sensor”).

In this case, the stick detection sensor and/or the cartridge detection sensor may be implemented as an inductance-based sensor, a capacitive sensor, a resistance sensor, or a Hall sensor (or Hall IC) using a Hall effect.

For example, the sensor module 15 may include a voltage sensor for sensing a voltage applied to a component (e.g. the battery 16) provided in the aerosol-generating device 10 and/or a current sensor for sensing a current.

The battery 16 may supply electric power used for the operation of the aerosol-generating device 10 under the control of the controller 17. The battery 16 may supply electric power to other components provided in the aerosol-generating device 100. For example, the battery 16 may supply electric power to the communication module included in the communication interface 11, the output device included in the input/output interface 12, and the heater included in the aerosol-generating module 13.

The battery 16 may be a rechargeable battery or a disposable battery. For example, the battery 16 may be a lithium-ion (Li-ion) battery or a lithium polymer (Li-polymer) battery. However, the present disclosure is not limited thereto. For example, when the battery 16 is rechargeable, the charging rate (C-rate) of the battery 16 may be 10C, and the discharging rate (C-rate) thereof may be 10C to 20C. However, the present disclosure is not limited thereto. Also, for stable use, the battery 16 may be manufactured such that 80% or more of the total capacity may be ensured even when charging/discharging is performed 2000 times.

The aerosol-generating device 10 may further include a protection circuit module (PCM) (not shown), which is a circuit for protecting the battery 16. The protection circuit module (PCM) may be disposed adjacent to the upper surface of the battery 16. For example, in order to prevent overcharging and overdischarging of the battery 16, the protection circuit module (PCM) may cut off the electrical path to the battery 16 when a short circuit occurs in a circuit connected to the battery 16, when an overvoltage is applied to the battery 16, or when an overcurrent flows through the battery 16.

The aerosol-generating device 10 may further include a charging terminal to which electric power supplied from the outside is input. For example, the charging terminal may be formed at one side of the main body of the aerosol-generating device 100. The aerosol-generating device 10 may charge the battery 16 using electric power supplied through the charging terminal. In this case, the charging terminal may be configured as a wired terminal for USB communication, a pogo pin, or the like.

The aerosol-generating device 10 may wirelessly receive electric power supplied from the outside through the communication interface 11. For example, the aerosol-generating device 10 may wirelessly receive electric power using an antenna included in the communication module for wireless communication. The aerosol-generating device 10 may charge the battery 16 using the wirelessly supplied electric power.

The controller 17 may control the overall operation of the aerosol-generating device 100. The controller 17 may be connected to each of the components provided in the aerosol-generating device 100. The controller 17 may transmit and/or receive a signal to and/or from each of the components, thereby controlling the overall operation of each of the components.

The controller 17 may include at least one processor. The controller 17 may control the overall operation of the aerosol-generating device 10 using the processor included therein. Here, the processor may be a general processor such as a central processing unit (CPU). Of course, the processor may be a dedicated device such as an application-specific integrated circuit (ASIC), or may be any of other hardware-based processors.

The controller 17 may perform any one of a plurality of functions of the aerosol-generating device 100. For example, the controller 17 may perform any one of a plurality of functions of the aerosol-generating device 10 (e.g. a preheating function, a heating function, a charging function, and a cleaning function) according to the state of each of the components provided in the aerosol-generating device 10 and the user's command received through the input/output interface 12.

The controller 17 may control the operation of each of the components provided in the aerosol-generating device 10 based on data stored in the memory 14. For example, the controller 17 may control the supply of a predetermined amount of electric power from the battery 16 to the aerosol-generating module 13 for a predetermined time based on the data on the temperature profile, the user's inhalation pattern, which is stored in the memory 14.

The controller 17 may determine the occurrence or non-occurrence of a puff using the puff sensor included in the sensor module 15. For example, the controller 17 may check a temperature change, a flow change, a pressure change, and a voltage change in the aerosol-generating device 10 based on the values sensed by the puff sensor. The controller 17 may determine the occurrence or non-occurrence of a puff based on the value sensed by the puff sensor.

The controller 17 may control the operation of each of the components provided in the aerosol-generating device 10 according to the occurrence or non-occurrence of a puff and/or the number of puffs. For example, the controller 17 may perform control such that the temperature of the heater is changed or maintained based on the temperature profile stored in the memory 14.

The controller 17 may perform control such that the supply of electric power to the heater is interrupted according to a predetermined condition. For example, the controller 17 may perform control such that the supply of electric power to the heater is interrupted when the stick is removed, when the cartridge is demounted, when the number of puffs reaches the predetermined maximum number of puffs, when a puff is not sensed during a predetermined period of time or longer, or when the remaining capacity of the battery 16 is less than a predetermined value.

The controller 17 may calculate the remaining capacity with respect to the full charge capacity of the battery 16. For example, the controller 17 may calculate the remaining capacity of the battery 16 based on the values sensed by the voltage sensor and/or the current sensor included in the sensor module 15.

The controller 17 may perform control such that electric power is supplied to the heater using at least one of a pulse width modulation (PWM) method or a proportional-integral-differential (PID) method.

For example, the controller 17 may perform control such that a current pulse having a predetermined frequency and a predetermined duty ratio is supplied to the heater using the PWM method. In this case, the controller 17 may control the amount of electric power supplied to the heater by adjusting the frequency and the duty ratio of the current pulse.

For example, the controller 17 may determine a target temperature to be controlled based on the temperature profile. In this case, the controller 17 may control the amount of electric power supplied to the heater using the PID method, which is a feedback control method using a difference value between the temperature of the heater and the target temperature, a value obtained by integrating the difference value with respect to time, and a value obtained by differentiating the difference value with respect to time.

Although the PWM method and the PID method are described as examples of methods of controlling the supply of electric power to the heater, the present disclosure is not limited thereto, and may employ any of various control methods, such as a proportional-integral (PI) method or a proportional-differential (PD) method.

Meanwhile, the controller 17 may perform control such that electric power is supplied to the heater according to a predetermined condition. For example, when a cleaning function for cleaning the space into which the stick is inserted is selected in response to a command input by the user through the input/output interface 12, the controller 17 may perform control such that a predetermined amount of electric power is supplied to the heater.

FIGS. 2 to 4 are views for explaining an aerosol-generating device according to embodiments of the present disclosure.

According to various embodiments of the present disclosure, the aerosol-generating device 10 may include a main body 100 and/or a cartridge 200.

Referring to FIG. 2, the aerosol-generating device 10 according to an embodiment may include a main body 100, which is formed such that a stick 20 can be inserted into the inner space formed by a housing 101.

The stick 20 may be similar to a general combustive cigarette. For example, the stick 20 may be divided into a first portion including an aerosol generating material and a second portion including a filter and the like. Alternatively, an aerosol generating material may be included in the second portion of the stick 20. For example, a flavoring substance made in the form of granules or capsules may be inserted into the second portion.

The entire first portion is inserted into the insertion space of the aerosol-generating device 10, and the second portion may be exposed to the outside. Alternatively, only a portion of the first portion may be inserted into the insertion space of the aerosol-generating device 10, or a portion of the first portion and the second portion may be inserted. In this case, the aerosol may be generated by passing external air through the first portion, and the generated aerosol may be delivered to the user's mouth through the second portion.

The main body 100 may be structured such that external air is introduced into the main body 100 in the state in which the stick 20 is inserted thereinto. In this case, the external air introduced into the main body 100 may flow into the mouth of the user via the stick 20.

The heater may be disposed in the main body 100 at a position corresponding to the position at which the stick 20 is inserted into the main body 100. Although it is illustrated in the drawings that the heater is an electrically conductive heater 110 including a needle-shaped electrically conductive track, the present disclosure is not limited thereto.

The heater may heat the interior and/or exterior of the stick 20 using the electric power supplied from the battery 16. An aerosol may be generated from the heated stick 20. At this time, the user may hold one end of the stick 20 in the mouth to inhale the aerosol containing a tobacco material.

Meanwhile, the controller 17 may perform control such that electric power is supplied to the heater in the state in which the stick 20 is not inserted into the main body according to a predetermined condition. For example, when a cleaning function for cleaning the space into which the stick 20 is inserted is selected in response to a command input by the user through the input/output interface 12, the controller 17 may perform control such that a predetermined amount of electric power is supplied to the heater.

The controller 17 may monitor the number of puffs based on the value sensed by the puff sensor from the point in time at which the stick 20 was inserted into the main body.

When the stick 20 is removed from the main body, the controller 17 may initialize the current number of puffs stored in the memory 14.

Referring to FIG. 3, the aerosol-generating device 10 according to an embodiment may include a main body 100 and a cartridge 200. The main body 100 may support the cartridge 200, and the cartridge 200 may contain an aerosol-generating substance.

According to one embodiment, the cartridge 200 may be configured so as to be detachably mounted to the main body 100. According to another embodiment, the cartridge 200 may be integrally configured with the main body 100. For example, the cartridge 200 may be mounted to the main body 100 in a manner such that at least a portion of the cartridge 200 is inserted into the insertion space formed by a housing 101 of the main body 100.

The main body 100 may be formed to have a structure in which external air can be introduced into the main body 100 in the state in which the cartridge 200 is inserted thereinto. Here, the external air introduced into the main body 100 may flow into the user's mouth via the cartridge 200.

The controller 17 may determine whether the cartridge 200 is in a mounted state or a detached state using a cartridge detection sensor included in the sensor module 15. For example, the cartridge detection sensor may transmit a pulse current through a first terminal connected with the cartridge 200. In this case, the controller 17 may determine whether the cartridge 200 is in a connected state, based on whether the pulse current is received through a second terminal.

The cartridge 200 may include a first heater 210 configured to heat the aerosol-generating substance and/or a reservoir 220 configured to contain the aerosol-generating substance. For example, a liquid delivery element impregnated with (containing) the aerosol-generating substance may be disposed inside the reservoir 220. The electrically conductive track of the first heater 210 may be formed in a structure that is wound around the liquid delivery element. In this case, when the liquid delivery element is heated by the heater 210, an aerosol may be generated. Here, the liquid delivery element may include a wick made of, for example, cotton fiber, ceramic fiber, glass fiber, or porous ceramic. The reservoir 220 storing liquid may be referred to as a chamber 200.

The cartridge 200 may include an insertion space 230 configured to allow the stick 20 to be inserted. For example, the cartridge 200 may include the insertion space formed by an inner wall extending in a circumferential direction along a direction in which the stick 20 is inserted. In this case, the insertion space may be formed by opening the inner side of the inner wall up and down. The stick 20 may be inserted into the insertion space formed by the inner wall.

The insertion space into which the stick 20 is inserted may be formed in a shape corresponding to the shape of a portion of the stick 20 inserted into the insertion space. For example, when the stick 20 is formed in a cylindrical shape, the insertion space may be formed in a cylindrical shape.

When the stick 20 is inserted into the insertion space, the outer surface of the stick 20 may be surrounded by the inner wall and contact the inner wall.

A portion of the stick 20 may be inserted into the insertion space, the remaining portion of the stick 20 may be exposed to the outside.

The user may inhale the aerosol while biting one end of the stick 20 with the mouth. The aerosol generated by the heater 210 may pass through the stick 20 and be delivered to the user's mouth. At this time, while the aerosol passes through the stick 20, the material contained in the stick 20 may be added to the aerosol. The material-infused aerosol may be inhaled into the user's oral cavity through the one end of the stick 20.

The cartridge 200 may include a second heater 215 configured to heat the stick 20. The second heater 215 may be disposed in the cartridge 200 at a position corresponding to a position at which the stick 20 is located after being inserted into the insertion space 230. The second heater 215 may be implemented as an electrically conductive heater and/or an induction heating type heater. The second heater 215 may heat the inside and/or the outside of the stick 20 using the power supplied from the battery 16.

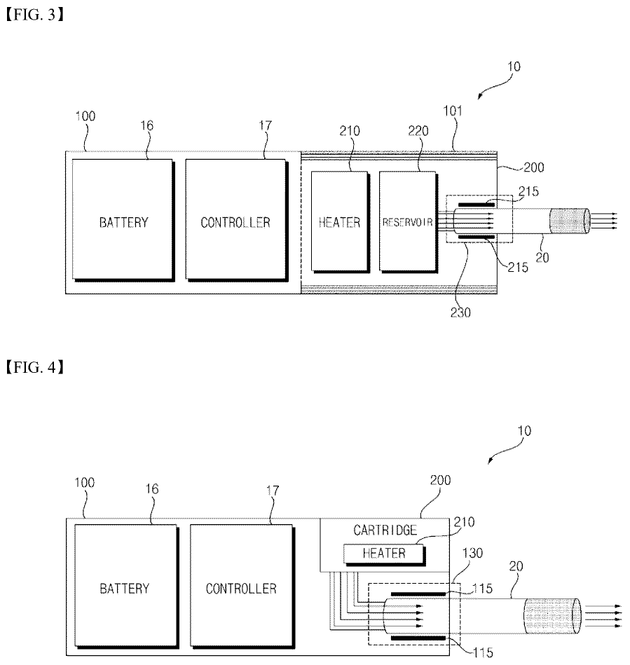

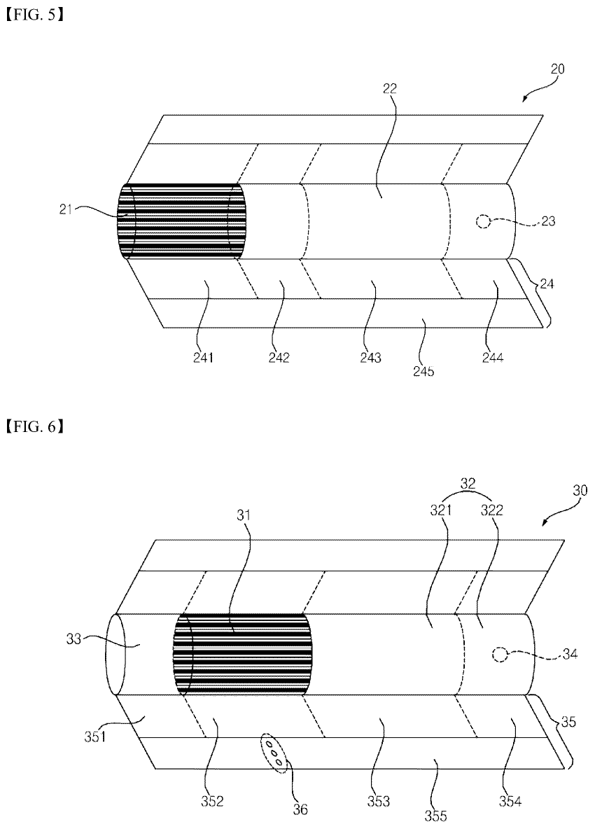

Referring to FIG. 4, the aerosol-generating device 10 according to an embodiment may include a main body 100 supporting the cartridge 200 and a cartridge 200 containing an aerosol-generating substance. The main body 100 may be formed so as to allow the stick 20 to be inserted into an insertion space 1300 therein.

The aerosol-generating device 10 may include the first heater 210 for heating for heating the aerosol-generating substance stored in the cartridge 200 and the second heater 215 for heating the stick 20 inserted into the main body 100, respectively. For example, the aerosol-generating device 10 may generate an aerosol by heating the aerosol-generating substance stored in the cartridge 200 and the stick 20 using the first heater 210 and the second heater 115, respectively.

Hereinafter, the present disclosure will be described on the basis of an embodiment in which the stick 20 is inserted into the insertion space 130 defined in the housing 101 of the main body 100.

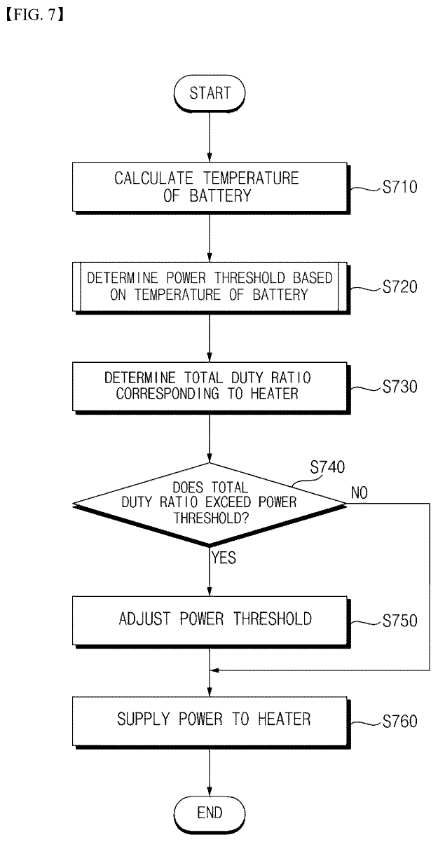

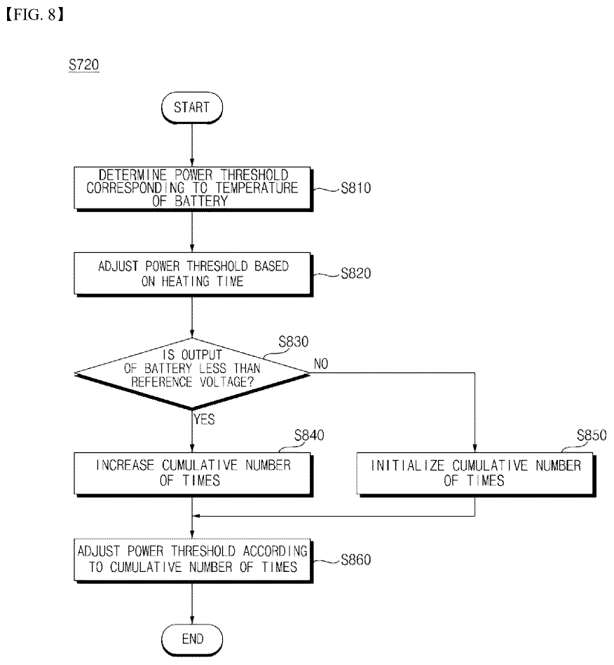

FIGS. 5 and 6 are views for explaining a stick according to embodiments of the present disclosure.

Referring to FIG. 5, the stick 20 may include a tobacco rod 21 and a filter rod 22. The first portion described above with reference to FIG. 2 may include the tobacco rod. The second portion described above with reference to FIG. 2 may include the filter rod 22.

FIG. 5 illustrates that the filter rod 22 includes a single segment. However, the filter rod 22 is not limited thereto. In other words, the filter rod 22 may include a plurality of segments. For example, the filter rod 22 may include a first segment configured to cool an aerosol and a second segment configured to filter a certain component included in the aerosol. Also, as necessary, the filter rod 22 may further include at least one segment configured to perform other functions.

A diameter of the stick 20 may be within a range of 5 mm to 9 mm, and a length of the stick 20 may be about 48 mm, but embodiments are not limited thereto. For example, a length of the tobacco rod 21 may be about 12 mm, a length of a first segment of the filter rod 22 may be about 10 mm, a length of a second segment of the filter rod 22 may be about 14 mm, and a length of a third segment of the filter rod 22 may be about 12 mm, but embodiments are not limited thereto.

The stick 20 may be wrapped using at least one wrapper 24. The wrapper 24 may have at least one hole through which external air may be introduced or internal air may be discharged. For example, the stick 20 may be wrapped using one wrapper 24. As another example, the stick 20 may be double-wrapped using at least two wrappers 24. For example, the tobacco rod 21 may be wrapped using a first wrapper 241. For example, the filter rod 22 may be wrapped using wrappers 242, 243, 244. The tobacco rod 21 and the filter rod 22 wrapped by wrappers may be combined. The stick 20 may be re-wrapped by a single wrapper 245. When each of the tobacco rod 21 and the filter rod 22 includes a plurality of segments, each segment may be wrapped using wrappers 242, 243, 244. The entirety of stick 20 composed of a plurality of segments wrapped by wrappers may be re-wrapped by another wrapper

The first wrapper 241 and the second wrapper 242 may be formed of general filter wrapping paper. For example, the first wrapper 241 and the second wrapper 242 may be porous wrapping paper or non-porous wrapping paper. Also, the first wrapper 241 and the second wrapper 242 may be made of an oil-resistant paper sheet and an aluminum laminate packaging material.

The third wrapper 243 may be made of a hard wrapping paper. For example, a basis weight of the third wrapper 243 may be within a range of 88 g/m2 to 96 g/m2. For example, the basis weight of the third wrapper 243 may be within a range of 90 g/m2 to 94 g/m2. Also, a total thickness of the third wrapper 243 may be within a range of 1200 μm to 1300 μm. For example, the total thickness of the third wrapper 243 may be 125 μm.

The fourth wrapper 244 may be made of an oil-resistant hard wrapping paper. For example, a basis weight of the fourth wrapper 244 may be within a range of about 88 g/m2 to about 96 g/m2. For example, the basis weight of the fourth wrapper 244 may be within a range of 90 g/m2 to 94 g/m2. Also, a total thickness of the fourth wrapper 244 may be within a range of 1200 μm to 1300 μm. For example, the total thickness of the fourth wrapper 244 may be 125 μm.

The fifth wrapper 245 may be made of a sterilized paper (MFW). Here, the MFW refers to a paper specially manufactured to have enhanced tensile strength, water resistance, smoothness, and the like, compared to ordinary paper. For example, a basis weight of the fifth wrapper 245 may be within a range of 57 g/m2 to 63 g/m2. For example, a basis weight of the fifth wrapper 245 may be about 60 g/m2. Also, the total thickness of the fifth wrapper 245 may be within a range of 64 μm to 70 μm. For example, the total thickness of the fifth wrapper 245 may be 67 μm.

A predetermined material may be included in the fifth wrapper 245. Here, an example of the predetermined material may be, but is not limited to, silicon. For example, silicon exhibits characteristics like heat resistance with little change due to the temperature, oxidation resistance, resistances to various chemicals, water repellency, electrical insulation, etc. However, any material other than silicon may be applied to (or coated on) the fifth wrapper 245 without limitation as long as the material has the above-mentioned characteristics.

The fifth wrapper 245 may prevent the stick 20 from being burned. For example, when the tobacco rod 21 is heated by the heater 110, there is a possibility that the stick 20 is burned. In detail, when the temperature is raised to a temperature above the ignition point of any one of materials included in the tobacco rod 21, the stick 20 may be burned. Even in this case, since the fifth wrapper 245 include a non-combustible material, the burning of the stick 20 may be prevented.

Furthermore, the fifth wrapper 245 may prevent the aerosol generating device 100 from being contaminated by substances formed by the stick 20. Through puffs of a user, liquid substances may be formed in the stick 20. For example, as the aerosol formed by the stick 20 is cooled by the outside air, liquid materials (e.g., moisture, etc.) may be formed. As the fifth wrapper 245 wraps the stick 20, the liquid materials formed in the stick 20 may be prevented from being leaked out of the stick 20.

The tobacco rod 21 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is injected to the tobacco rod 21.

The tobacco rod 21 may be manufactured in various forms. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat conductive material. For example, the heat-conducting material may be, but is not limited to, a metal foil such as aluminum foil. For example, the heat conductive material surrounding the tobacco rod 21 may uniformly distribute heat transmitted to the tobacco rod 21, and thus, the heat conductivity applied to the tobacco rod may be increased and taste of the tobacco may be improved. Also, the heat conductive material surrounding the tobacco rod 21 may function as a susceptor heated by the induction heater. Here, although not illustrated in the drawings, the tobacco rod 21 may further include an additional susceptor, in addition to the heat conductive material surrounding the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

The first segment of the filter rod 22 may be a cellulous acetate filter. For example, the first segment may be a tube-type structure having a hollow inside. The first segment may prevent an internal material of the tobacco rod 21 from being pushed back when the heater 110 is inserted into the tobacco rod 21 and may also provide a cooling effect to aerosol. A diameter of the hollow included in the first segment may be an appropriate diameter within a range of 2 mm to 4.5 mm but is not limited thereto.

The length of the first segment may be an appropriate length within a range of 4 mm to 30 mm but is not limited thereto. For example, the length of the first segment may be 10 mm but is not limited thereto.

The second segment of the filter rod 22 cools the aerosol which is generated when the heater 110 heats the tobacco rod 21. Therefore, the user may puff the aerosol which is cooled at an appropriate temperature.

The length or diameter of the second segment may be variously determined according to the shape of the stick 20. For example, the length of the second segment may be an appropriate length within a range of 7 mm to 20 mm. Preferably, the length of the second segment may be about 14 mm but is not limited thereto.

The second segment may be manufactured by weaving a polymer fiber. In this case, a flavoring liquid may also be applied to the fiber formed of the polymer. Alternatively, the second segment may be manufactured by weaving together an additional fiber coated with a flavoring liquid and a fiber formed of a polymer. Alternatively, the second segment may be formed by a crimped polymer sheet.

For example, a polymer may be formed of a material selected from the group consisting of polyethylene (PE), polypropylene (PP), polyvinyl chloride (PVC), polyethylene terephthalate (PET), polylactic acid (PLA), cellulous acetate (CA), and aluminum coil.

As the second segment is formed by the woven polymer fiber or the crimped polymer sheet, the second segment may include a single channel or a plurality of channels extending in a longitudinal direction. Here, a channel refers to a passage through which a gas (e.g., air or aerosol) passes.

For example, the second segment formed of the crimped polymer sheet may be formed from a material having a thickness between about 5 μm and about 300 μm, for example, between about 10 μm and about 250 μm. Also, a total surface area of the second segment may be between about 300 mm2/mm and about 1000 mm2/mm. In addition, an aerosol cooling element may be formed from a material having a specific surface area between about 10 mm2/mg and about 100 mm2/mg.

The second segment may include a thread including a volatile flavor component. Here, the volatile flavor component may be menthol but is not limited thereto. For example, the thread may be filled with a sufficient amount of menthol to provide the second segment with menthol of 1.5 mg or more.

The third segment of the filter rod 22 may be a cellulous acetate filter. The length of the third segment may be an appropriate length within a range of 4 mm to 20 mm. For example, the length of the third segment may be about 12 mm but is not limited thereto.

The filter rod 22 may be manufactured to generate flavors. For example, a flavoring liquid may be injected onto the filter rod 22. For example, an additional fiber coated with a flavoring liquid may be inserted into the filter rod 22.

Also, the filter rod 22 may include at least one capsule 23. Here, the capsule 23 may generate a flavor. The capsule 23 may generate an aerosol. For example, the capsule 23 may have a configuration in which a liquid including a flavoring material is wrapped with a film. The capsule 23 may have a spherical or cylindrical shape but is not limited thereto.

Referring to FIG. 6, a stick 30 may further include a front-end plug 33. The front-end plug 33 may be located on a side of a tobacco rod 31, the side not facing a filter rod 32. The front-end plug 33 may prevent the tobacco rod 31 from being detached and prevent liquefied aerosol from flowing into the aerosol generating device 10 from the tobacco rod 31, during smoking.

The filter rod 32 may include a first segment 321 and a second segment 322. The first segment 321 may correspond to the first segment of the filter rod 22 of FIG. 4. The segment 322 may correspond to the third segment of the filter rod 22 of FIG. 4.

A diameter and a total length of the stick 30 may correspond to the diameter and a total length of the stick 20 of FIG. 4. For example, a length of the front-end plug 33 may be about 7 mm, a length of the tobacco rod 31 may be about 15 mm, a length of the first segment 321 may be about 12 mm, and a length of the second segment 322 may be about 14 mm, but embodiments are not limited thereto.

The stick 30 may be wrapped using at least one wrapper 35. The wrapper 35 may have at least one hole through which external air may be introduced or internal air may be discharged. For example, the front-end plug 33 may be wrapped using a first wrapper 351, the tobacco rod 31 may be wrapped using a second wrapper 352, the first segment 321 may be wrapped using a third wrapper 353, and the second segment 322 may be wrapped using a fourth wrapper 354. Also, the entire stick 30 may be rewrapped using a fifth wrapper 355.

In addition, the fifth wrapper 355 may have at least one perforation 36 formed therein. For example, the perforation 36 may be formed in an area of the fifth wrapper 355 surrounding the tobacco rod 31 but is not limited thereto. For example, the perforation 36 may transfer heat formed by the heater 210 illustrated in FIG. 3 into the tobacco rod 31.

Also, the second segment 322 may include at least one capsule 34. Here, the capsule 34 may generate a flavor. The capsule 34 may generate an aerosol. For example, the capsule 34 may have a configuration in which a liquid including a flavoring material is wrapped with a film. The capsule 34 may have a spherical or cylindrical shape but is not limited thereto.

The first wrapper 351 may be formed by combining general filter wrapping paper with a metal foil such as an aluminum coil. For example, a total thickness of the first wrapper 351 may be within a range of 45 μm to 55 μm. For example, the total thickness of the first wrapper 351 may be 50.3 μm. Also, a thickness of the metal coil of the first wrapper 351 may be within a range 6 μm to 7 μm. For example, the thickness of the metal coil of the first wrapper 351 may be 6.3 μm. In addition, a basis weight of the first wrapper 351 may be within a range of 50 g/m2 to 55 g/m2. For example, the basis weight of the first wrapper 351 may be 53 g/m2.

The second wrapper 352 and the third wrapper 353 may be formed of general filter wrapping paper. For example, the second wrapper 352 and the third wrapper 353 may be porous wrapping paper or non-porous wrapping paper.

For example, porosity of the second wrapper 352 may be 35000 CU but is not limited thereto. Also, a thickness of the second wrapper 352 may be within a range of 70 μm to 80 μm. For example, the thickness of the second wrapper 352 may be 78 μm. A basis weight of the second wrapper 352 may be within a range of 20 g/m2 to 25 g/m2. For example, the basis weight of the second wrapper 352 may be 23.5 g/m2.

For example, porosity of the third wrapper 353 may be 24000 CU but is not limited thereto. Also, a thickness of the third wrapper 353 may be in a range of about 60 μm to about 70 μm. For example, the thickness of the third wrapper 353 may be 68 μm. A basis weight of the third wrapper 353 may be in a range of about 20 g/m2 to about 25 g/m2. For example, the basis weight of the third wrapper 353 may be 21 g/m2.

The fourth wrapper 354 may be formed of PLA laminated paper. Here, the PLA laminated paper refers to three-layer paper including a paper layer, a PLA layer, and a paper layer. For example, a thickness of the fourth wrapper 353 may be in a range of 100 μm to 1200 μm. For example, the thickness of the fourth wrapper 353 may be 110 μm. Also, a basis weight of the fourth wrapper 354 may be in a range of 80 g/m2 to 100 g/m2. For example, the basis weight of the fourth wrapper 354 may be 88 g/m2.

The fifth wrapper 355 may be formed of sterilized paper (MFW). Here, the sterilized paper (MFW) refers to paper which is particularly manufactured to improve tensile strength, water resistance, smoothness, and the like more than ordinary paper. For example, a basis weight of the fifth wrapper 355 may be in a range of 57 g/m2 to 63 g/m2. For example, the basis weight of the fifth wrapper 355 may be 60 g/m2. Also, a thickness of the fifth wrapper 355 may be in a range of 64 μm to 70 μm. For example, the thickness of the fifth wrapper 355 may be 67 μm.

The fifth wrapper 355 may include a preset material added thereto. An example of the material may include silicon, but it is not limited thereto. Silicon has characteristics such as heat resistance robust to temperature conditions, oxidation resistance, resistance to various chemicals, water repellency to water, and electrical insulation, etc. Besides silicon, any other materials having characteristics as described above may be applied to (or coated on) the fifth wrapper 355 without limitation.

The front-end plug 33 may be formed of cellulous acetate. For example, the front-end plug 33 may be formed by adding a plasticizer (e.g., triacetin) to cellulous acetate tow. Mono-denier of filaments constituting the cellulous acetate tow may be in a range of 1.0 to 10.0. For example, the mono-denier of filaments constituting the cellulous acetate tow may be within a range of 4.0 to 6.0. For example, the mono-denier of the filaments of the front-end plug 33 may be 5.0. Also, a cross-section of the filaments constituting the front-end plug 33 may be a Y shape. Total denier of the front-end plug 33 may be in a range of 20000 to 30000. For example, the total denier of the front-end plug 33 may be within a range of 25000 to 30000. For example, the total denier of the front-end plug 33 may be 28000.

Also, as needed, the front-end plug 33 may include at least one channel. A cross-sectional shape of the channel may be manufactured in various shapes.

The tobacco rod 31 may correspond to the tobacco rod 21 described above with reference to FIG. 4. Therefore, hereinafter, the detailed description of the tobacco rod 31 will be omitted.

The first segment 321 may be formed of cellulous acetate. For example, the first segment 321 may be a tube-type structure having a hollow inside. The first segment 321 may be manufactured by adding a plasticizer (e.g., triacetin) to cellulous acetate tow. For example, mono-denier and total denier of the first segment 321 may be the same as the mono-denier and total denier of the front-end plug 33.

The second segment 322 may be formed of cellulous acetate. Mono denier of filaments constituting the second segment 322 may be in a range of 1.0 to 10.0. For example, the mono denier of the filaments of the second segment 322 may be within a range of about 8.0 to about 10.0. For example, the mono denier of the filaments of the second segment 322 may be 9.0. Also, a cross-section of the filaments of the second segment 322 may be a Y shape. Total denier of the second segment 322 may be in a range of 20000 to 30000. For example, the total denier of the second segment 322 may be 25000.

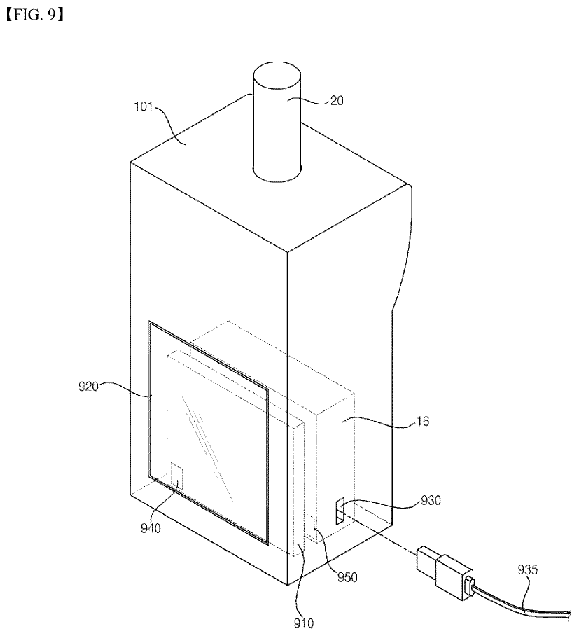

FIGS. 7 and 8 are flowcharts showing an operation method of an aerosol-generating device 10 according to an embodiment of the present disclosure.

Referring to FIG. 7, the aerosol generating device 10 may detect the temperature of the battery 16 through a temperature sensor configured to sense the temperature of the battery 16 in operation S710. For example, the power of the aerosol generating device 10 may be turned on based on insertion of the stick 20 into the insertion space 130 formed in the housing 101. At this time, the aerosol generating device 10 may detect the temperature of the battery 16. For example, the aerosol generating device 10 may detect the temperature of the battery 16 according to a predetermined period.

Regarding detecting the temperature of the battery 16, it will be described with reference to FIG. 9.

Referring to FIG. 9, according to an embodiment of the present disclosure, the insertion space, into which the stick 20 is inserted, may be defined in the upper end of the housing 101 of the aerosol generating device 10.

The insertion space may be formed so as to be depressed to a predetermined depth toward the interior of the housing 101 so that the stick 20 is inserted at least partway thereinto. The depth of the insertion space may correspond to the length of the portion of the stick 20 that contains an aerosol-generating substance. For example, in the case in which the stick 20 shown in FIG. 5 is capable of being used in the aerosol-generating device 10, the depth of the insertion space may correspond to the length of a tobacco rod 21 of the stick 20.

Components such as battery 16, the printed circuit board 170, and the heater may be disposed in the housing 101 of the aerosol-generating device 10.

The components of the aerosol-generating device 10 may be mounted on one surface and/or the opposite surface of the printed circuit board 910. The components mounted on the printed circuit board 910 may transmit or receive signals therebetween through a wiring layer of the printed circuit board 910. For example, at least one communication module included in the communication interface 11, at least one sensor included in the sensor module 15, the controller 17 and the like may be mounted on the printed circuit board 170.

The printed circuit board 910 may be disposed adjacent to the battery 16. For example, the printed circuit board 910 may be disposed such that one surface thereof faces the battery 16.

A display 920 may be disposed on one side of the housing 101. The display 920 may display a screen in response to a signal transmitted from the controller 17.

A power terminal 930 may be disposed on one side of the housing 101 of the aerosol generating device 10. The power terminal 930 may be a wired terminal for wired communication such as USB.

A power supply circuit may be disposed between the battery 16 and the power terminal 930. The power supply circuit may transmit power supplied from the outside to the battery 16 through the power terminal 930. A power line 935 for supplying power may be connected to the power terminal 930. For example, the power terminal 930 may be coupled to a connector of the power line 935. The controller 17 may determine whether the power line 935 is connected to the power terminal 930. For example, the controller 17 may determine whether the power line 935 is connected to the power terminal 930 based on a signal generated in response to connection between the power terminal 930 and the power line 935.

A motor 940, which generates vibration for a haptic effect, may be disposed in the housing 101. The motor 940 may adjust the period and/or intensity of vibration based on a signal transmitted from the controller 17.

A temperature sensor 950, which senses a temperature of the battery 16, may be disposed in the housing 101. The temperature sensor 950 may be disposed adjacent to the battery 16. For example, the temperature sensor 950 may be mounted on one surface of the battery 16. Meanwhile, the temperature sensor 950 may be mounted on one surface of the printed circuit board 910.

The temperature sensor 950 may be implemented using a thermistor, which is a device whose resistance changes with temperature, or the like. For example, the temperature sensor 950 may include a negative temperature coefficient thermistor (NTC thermistor) whose resistance decreases as temperature increases.

The structure of the aerosol-generating device 10 is not limited to the structure shown in FIG. 9. In some embodiments, the arrangement of the battery 16, the printed circuit board 910, the display 920, the power terminal 930, the motor 940, the temperature sensor 950, and the like may vary.

The aerosol generating device 10 may determine a threshold (hereinafter, a power threshold) for a duty ratio corresponding to an output of the battery 16 based on the temperature of the battery 16 in operation S720.

When the temperature of the battery 16 is less than a certain temperature, the performance of the battery 16 may deteriorate due to causes such as a significant decrease in the mobility of lithium ions. At this time, when the output of the battery 16 drops due to the performance degradation of the battery 16, the user may not be able to use the aerosol generating device 10 because of an operation of the protection circuit module (PCM). Considering this point, the aerosol generating device 10 according to an embodiment of the present disclosure may determine a power threshold based on the temperature of the battery 16. The determination of the power threshold based on the temperature of the battery 16 will be described with reference to FIG. 8.

Referring to FIG. 8, the aerosol generating device 10 may determine a threshold corresponding to the temperature of the battery 16 in operation S810. For example, the aerosol generating device 10 may determine the threshold corresponding to the temperature of the battery 16 based on a look-up table stored in the memory 14, which is related to the correspondence between at least one temperature of the battery 16 and at least one threshold. Here, the threshold corresponding to the temperature of the battery 16 may increase in response to an increase in the temperature of the battery 16 in a predetermined temperature range.

Referring to FIG. 10, the aerosol generating device 10 may determine that the supply of power to the heaters 115 and 210 is impossible when the temperature of the battery 16 is less than a predetermined minimum temperature (e.g., −15° C.). At this time, the aerosol generating device 10 may determine the threshold corresponding to the temperature of the battery 16 as 0% based on the temperature of the battery 16 being less than −15° C., which is the predetermined minimum temperature. At this time, as the threshold corresponding to the temperature of the battery 16 is determined to be 0%, the supply of power to the heaters 115 and 210 may be cut off.

When the temperature of the battery 16 is equal to or greater than the predetermined minimum temperature (e.g., −15° C.), the threshold corresponding to the temperature of the battery 16 may increase in proportion to the increase in the temperature of the battery 16. The threshold corresponding to the temperature of the battery 16 may be increased to a predetermined maximum duty ratio Dmax. Here, the maximum duty ratio Dmax may be a preset duty ratio (e.g., 90%) in consideration of stable supply of power to components included in the aerosol generating device 10 such as the heaters 115 and 210.

On the other hand, the aerosol generating device 10 may determine the threshold corresponding to the temperature of the battery 16 as the maximum duty ratio Dmax when the temperature of the battery 16 is equal to or greater than a predetermined reference temperature (e.g., 10° C.)

The aerosol generating device 10 may adjust the threshold corresponding to the temperature of the battery 16 based on the time during which power is supplied to the heaters 115 and 210 (hereinafter referred to as heating time) in operation S820. Here, the heating time may be a time elapsed from the point in time when the supply of power to the heaters 115 and 210 is started after the aerosol generating device 10 is turned on. For example, the aerosol generating device 10 may start the supply of power to the heaters 115 and 210 based on the insertion of the stick 20 into the insertion space 130 formed in the housing 101.

When power is supplied from the battery 16 after the aerosol generating device 10 is turned on, a voltage drop may occur at the output of the battery 16. For example, when an inrush current flows due to a state of charge of a capacitor among components included in the aerosol generating device 10, the voltage drop may occur at the output voltage of the battery 16. Considering this point, the aerosol generating device 10 according to an embodiment of the present disclosure may adjust the threshold corresponding to the temperature of the battery 16 based on the heating time. On the other hand, according to one embodiment, the aerosol generating device 10 may adjust the threshold corresponding to the temperature of the battery 16 based on a time elapsed from the point in time when the supply of power from the battery 16 is started after the aerosol generating device 10 is turned on.

The threshold adjusted based on the heating time may be less than or equal to the threshold corresponding to the temperature of the battery 16. At this time, the difference between the threshold corresponding to the temperature of the battery 16 and the adjusted threshold may decrease in response to an increase in the heating time. That is, as the heating time increases, the degree to which the threshold corresponding to the temperature of the battery 16 is adjusted according to the heating time may decrease.

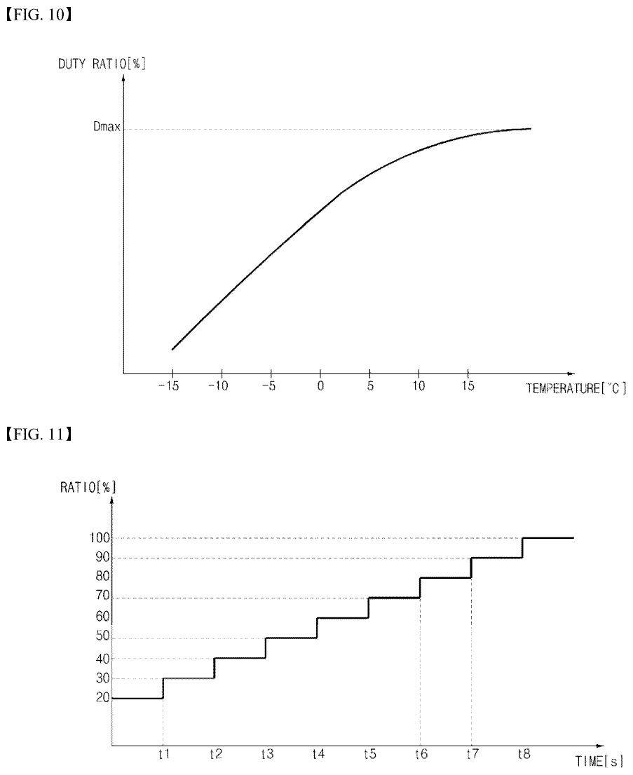

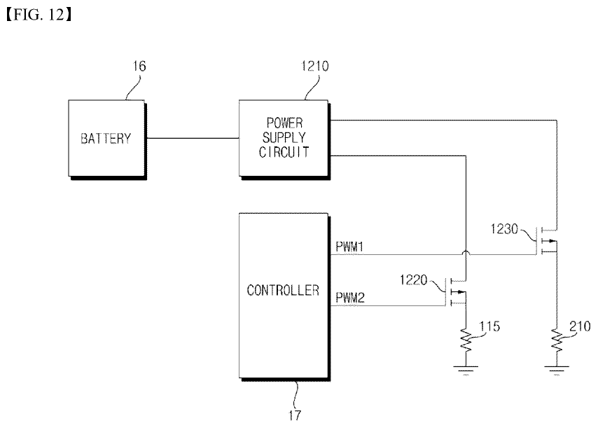

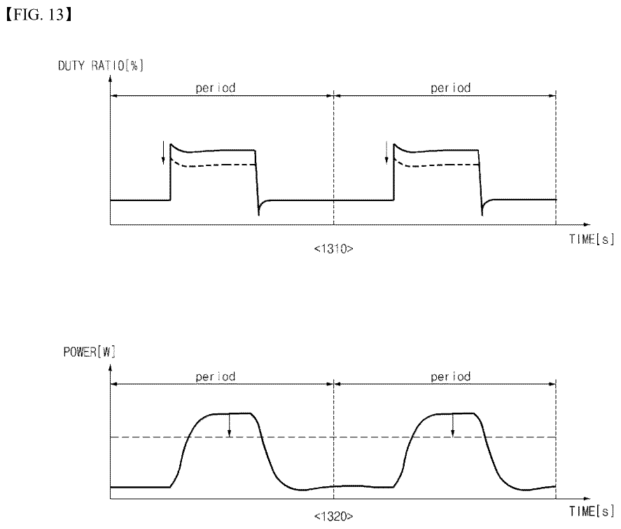

Referring to FIG. 11, the aerosol generating device 10 may adjust the threshold corresponding to the temperature of the battery 16 based on a ratio for adjustment corresponding to the heating time. The aerosol generating device 10 may determine a result obtained by multiplying the threshold corresponding to the temperature of the battery 16 by the ratio for adjustment corresponding to the heating time as the adjusted threshold.

The ratio for adjustment corresponding to the heating time may increase correspondingly to an increase in the heating time. For example, the ratio for adjustment may be increased stepwise by 10% from the lowest ratio of 20% corresponding to the increase in heating time. At this time, the ratio for adjustment may be increased to 100%, which is the maximum ratio. Meanwhile, when a predetermined time has elapsed from the point in time when the supply of power to the heaters 115 and 210 is started, the ratio for adjustment may be determined to be 100%. That is, after the predetermined time has elapsed from the point in time when the supply of power to the heaters 115 and 210 is started, the adjustment regarding the threshold corresponding to the temperature of the battery 16 based on the heating time may be omitted.

The aerosol generating device 10 may determine whether the output of the battery 16 is less than a predetermined reference voltage in operation S830. Here, the reference voltage may correspond to a voltage at which the protection circuit module (PCM) operates to prevent overdischarge of the battery 16. For example, the aerosol generating device 10 may determine whether the output of the battery 16 is less than 2.8V set as the reference voltage.

When the output of the battery 16 is less than the reference voltage, the aerosol generating device 10 may increase a cumulative number of times the output of the battery 16 is less than the reference voltage in operation S840. For example, the aerosol generating device 10 may increase the cumulative number of times by 1 when the output of the battery 16 is less than the reference voltage.

Meanwhile, the aerosol generating device 10 may initialize the cumulative number of times when the output of the battery 16 is equal to or greater than the reference voltage in operation S850. For example, the aerosol generating device 10 may initialize the cumulative number of times to 0 when the output of the battery 16 is equal to or greater than the reference voltage.

The aerosol generating device 10 may adjust the threshold corresponding to the temperature of the battery 16 according to the cumulative number of times in operation S860. For example, the aerosol generating device 10 may additionally adjust the threshold corresponding to the temperature of the battery 16 adjusted based on the heating time according to the cumulative number of times.

The threshold adjusted according to the cumulative number of times may be less than or equal to the threshold corresponding to the temperature of the battery 16. In this case, a difference between the threshold corresponding to the temperature of the battery 16 and the threshold adjusted according to the cumulative number of times may increase corresponding to an increase in the cumulative number of times. That is, as the number of times the output of the battery 16 is less than the reference voltage increases, the degree to which the threshold corresponding to the temperature of the battery 16 is adjusted may increase according to the cumulative number of times. For example, the aerosol generating device 10 may decrease the threshold corresponding to the temperature of the battery 16 by 1% when the cumulative number of times is 1. For example, the aerosol generating device 10 may decrease the threshold corresponding to the temperature of the battery 16 by 5% when the cumulative number of times is 5.

Referring to FIG. 7, the aerosol generating device 10 may determine a total duty ratio corresponding to the heater in operation S730. For example, when the plurality of heaters 115 and 210 are included, the aerosol generating device 10 may determine a result obtained by summing the duty ratios corresponding to the plurality of heaters 115 and 210 as a total duty ratio. For example, when a duty ratio corresponding to the first heater 210 is 50% and a duty ratio corresponding to the second heater 115 is 30%, the total duty ratio may be calculated as 80%.

Referring to FIG. 12, when the plurality of heaters 115 and 210 are included, the aerosol generating device 10 may include a power supply circuit 1210, a first switching element 1220 corresponding to the first heater 210 and/or a second switching element 1230 corresponding to the second heater 115.

The power supply circuit 1210 may be electrically connected to the battery 16. The power supply circuit 1210 may supply power to each component of the aerosol generating device 10 based on the power stored in the battery 16. For example, the power supply circuit 1210 may supply power to the plurality of heaters 115 and 210, respectively.

According to one embodiment, the power supply circuit 1210 may convert a voltage output from the battery 16. For example, the power supply circuit 1210 may include a buck-converter that steps down the voltage output from the battery 16. In the present disclosure, the buck converter is described as an example of a configuration for converting a voltage, but embodiments are not limited thereto. For example, the power supply circuit 1210 may include a buck-boost converter, a Zener diode, and the like.

According to one embodiment, the power supply circuit 1210 may output an AC current having a predetermined frequency. The power supply circuit 1210 may output the AC current based on a DC voltage of the battery 16. Meanwhile, in the present disclosure, the power supply circuit 1210 is described as outputting the AC current, but it may be understood that the power supply circuit 1210 outputs an AC voltage or an AC power. For example, when the second heater 115 is an induction heater, the power supply circuit 1210 may output the AC current having the predetermined frequency to the second heater 115.

The power supply circuit 1210 may include an inverter that converts a DC current into an AC current. The inverter may output the AC current according to an operation of a plurality of switching elements. For example, when the plurality of switching elements included in the inverter are insulated gate bipolar transistors (IGBTs), the controller 17 may output a switching signal corresponding to a predetermined frequency to a gate of the switching elements. In this case, the AC current having the predetermined frequency may be output from the power supply circuit 1210 by the operation of the switching element according to the switching signal. Here, the switching signal may be a PWM signal. Meanwhile, in the present disclosure, the IGBT is described as an example of the switching element, but embodiments are not limited thereto.

The first switching element 1220 and/or the second switching element 1230 may operate based on control signals PWM1 and PWM2 output from the controller 17. The first switching element 1220 and/or the second switching element 1230 may be transistor elements. For example, the first switching element 1220 and/or the second switching element 1230 may be implemented by a Bipolar Junction Transistor (BJT), a Field Effective Transistor (FET), or the like. Meanwhile, in the present disclosure, the transistor element is described as an example of the first switching element 1220 and/or the second switching element 1230, but embodiments are not limited thereto.

The control signals PWM1 and PWM2 output from the controller 17 may be pulse currents having a predetermined duty ratio. The controller 17 may adjust power supplied to at least one of the heaters 115 and 210 by adjusting the duty ratio of the control signals PWM1 and PWM2 input to the first switching element 1220 and/or the second switching element 1230.

The aerosol generating device 10 may determine a value obtained by summing the duty ratios of the control signals PWM1 and PWM2 input to the first switching element 1220 and/or the second switching element 1230 as the total duty ratio corresponding to the heater.

According to an embodiment, when the aerosol generating device 10 includes one heater (e.g., the heater 110), a duty ratio corresponding to the heater may be determined as the total duty ratio.

The aerosol generating device 10 may determine whether the total duty ratio corresponding to the heater exceeds the power threshold in operation S740.

The aerosol generating device 10 may adjust the duty ratio corresponding to the heater based on the total duty ratio corresponding to the heater exceeding the power threshold in operation S750.

According to an embodiment, when the aerosol generating device 10 includes one heater (e.g., the heater 110), the duty ratio corresponding to the heater 110 may be adjusted.

Referring to FIG. 13, the aerosol generating device 10 may decrease the duty ratio corresponding to the heater 110 to the power threshold or less (1310). At this time, the power supplied to the heater 110 may be reduced to less than or equal to the power corresponding to the power threshold in response to the decrease in the duty ratio corresponding to the heater 110 (1320).

According to an embodiment, when the aerosol generating device 10 includes a plurality of heaters 115 and 210, at least one of duty ratios corresponding to the plurality of heaters 115 and 210 may be adjusted.

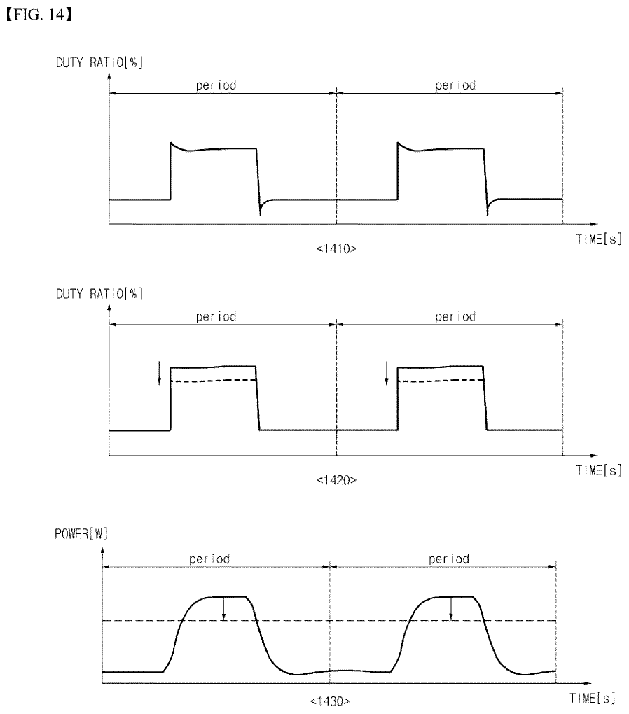

Referring to FIG. 14, the aerosol generating device 10 may decrease one of the duty ratios corresponding to each of the plurality of heaters 115 and 210 by a difference between the total duty ratio and the power threshold (1410 and 1420). In this case, the power supplied to the heater 110 may be reduced below the power corresponding to the power threshold in response to the decrease in the duty ratio corresponding to any one of the plurality of heaters 115 and 210 (1430).

Meanwhile, the aerosol generating device 10 may decrease all duty ratios corresponding to each of the plurality of heaters 115 and 210. In this case, a total decrement of the duty ratios corresponding to each of the plurality of heaters 115 and 210 may correspond to the difference between the total duty ratio and the power threshold.

According to an embodiment, when the aerosol generating device 10 includes the plurality of heaters 115 and 210, at least one of duty ratios corresponding to each of the plurality of heaters 115 and 210 may be adjusted based on priorities of the plurality of heaters 115 and 210. Here, the priorities of the plurality of heaters 115 and 210 may be changed according to user input. For example, a priority of the first heater 210 for heating the liquid aerosol-generating substance may be higher than a priority of the second heater 115 for heating the stick 20. At this time, the aerosol generating device 10 may decrease the duty ratio corresponding to the second heater 115 having a lower priority among the plurality of heaters 115 and 210 by the difference between the total duty ratio and the power threshold.

Meanwhile, the aerosol generating device 10 may decrease all duty ratios corresponding to each of the plurality of heaters 115 and 210. In this case, a decrement of the duty ratio corresponding to the second heater 115 may be greater than a decrement of the duty ratio corresponding to the first heater 210 based on the priority of the first heater 210 being higher than that of the second heater 115. Meanwhile, the sum of the decrement of the duty ratio corresponding to the first heater 210 and the decrement of the duty ratio corresponding to the second heater 115 may correspond to the difference between the total duty ratio and the power threshold.

The aerosol generating device 10 may supply power to the heater based on the duty ratio corresponding to the heater in operation S760. For example, when the aerosol generating device 10 includes a plurality of heaters 115 and 210, the power may be supplied to each of the plurality of heaters 115 and 210 based on the duty ratios corresponding to each of the plurality of heaters 115 and 210.

According to an embodiment, the aerosol generating device 10 may perform an operation of adjusting the duty ratio corresponding to the heater according to the power threshold determined based on the temperature of the battery 16 according to a predetermined cycle. For example, the aerosol generating device 10 may perform an operation of determining the power threshold based on the temperature of the battery 16 and an operation of adjusting the duty ratio corresponding to the heater based on the power threshold according to a control cycle related to the PID method using feedback.

According to one embodiment, in the case in which the aerosol generating device 10 includes the plurality of heaters 115 and 210, a phase of an on-duty section in which power is supplied to the plurality of heaters 115 and 210 may be adjusted based on the total duty ratio corresponding to the heater exceeding the power threshold.

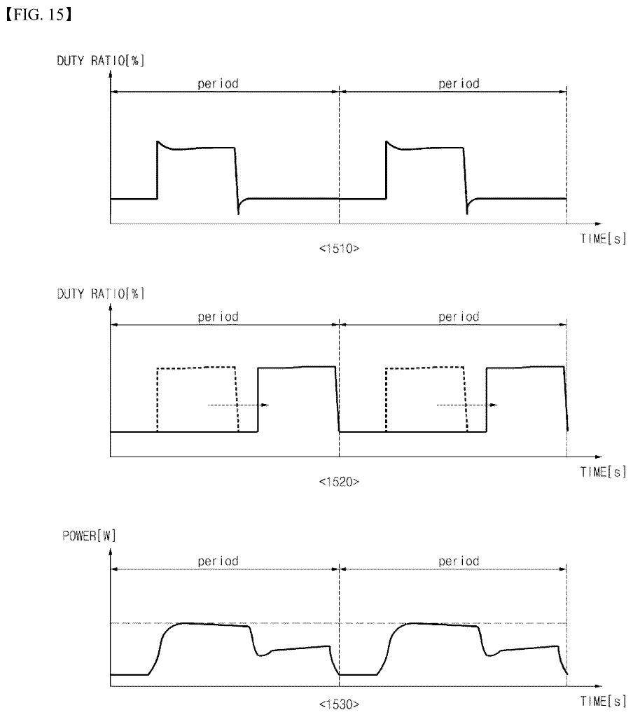

Referring to FIG. 15, the aerosol generating device 10 may adjust a phase of an on-duty section corresponding to one of the plurality of heaters 115 and 210 so that on-duty sections corresponding to each of the plurality of heaters 115 and 210 does not overlap each other (1510, 1520). At this time, the power supplied to the heaters 115 and 210 may be less than or equal to a power corresponding to the power threshold in the on-duty sections corresponding to each of the plurality of heaters 115 and 210 (1530).

As described above, according to at least one of the embodiments of the present disclosure, it may be possible to ensure stability of control for the heaters 115, 210 and heating performance based on a voltage currently output from the battery 16.

In addition, according to at least one of the embodiments of the present disclosure, it may be possible to ensure stability of control for the heaters 115, 210 and heating performance based on a voltage currently output from the battery 16.

In addition, according to at least one of the embodiments of the present disclosure, it may be possible to ensure stability of control for the heaters 115, 210 and heating performance based on based on a time power has been supplied from the battery 16.

Referring to FIGS. 1 to 15, an aerosol-generating device 10 in accordance with one aspect of the present disclosure may include a battery 16, a temperature sensor 950 configured to sense a temperature of the battery 16, a plurality of heaters 115, 210, and a controller 17. The controller 17 may determine a threshold for a duty ratio corresponding to an output of the battery 16, based on the temperature of the battery 16, and adjust at least one of duty ratios corresponding to each of the plurality of heaters 115, 210 based on a total duty ratio corresponding to the plurality of heaters 115, 210 equal to or greater than the threshold.

In addition, in accordance with another aspect of the present disclosure, the aerosol-generating device may further include a chamber 220 configured to store a liquid, and a housing 101 having an elongated insertion space 130. The plurality of heaters 115, 210 may comprise a first heater 210 configured to heat the liquid, and a second heater 115 configured to heat a stick inserted into the insertion space 130.

In addition, in accordance with another aspect of the present disclosure, the controller 17 may decrease a duty ratio corresponding to a heater having the lowest priority among the plurality of heaters 115, 210, based on priorities of the plurality of heaters 115, 210.

In addition, in accordance with another aspect of the present disclosure, the controller 17 may decrease the duty ratios corresponding to each of the plurality of heaters 115, 210, based on priorities of the plurality of heaters 115, 210. A first decrement of a duty ratio corresponding to a first heater 210 may be greater than a second decrement of a duty ratio corresponding to a second heater 115 based on a priority of the second heater 115 being higher than that of the first heater.

In addition, in accordance with another aspect of the present disclosure, the controller 17 may determine a first threshold corresponding to the temperature of the battery 16, and determine a second threshold less than or equal to the first threshold as a threshold for the total duty ratio, based on a heating time during which power is supplied to at least one of the plurality of heaters 115, 210. A difference between the first threshold and the second threshold may decrease corresponding to an increase in the heating time.

In addition, in accordance with another aspect of the present disclosure, the controller 17 may calculate a value obtained by multiplying the first threshold by a ratio for adjustment corresponding to the heating time as the second threshold. The ratio for adjustment may increase corresponding to the increase in the heating time.

In addition, in accordance with another aspect of the present disclosure, the controller 17 may determine a first threshold corresponding to the temperature of the battery 16, and determine a second threshold equal to or less than the first threshold as a threshold for the total duty ratio, based on a cumulative number of times an output of the battery 16 is less than a predetermined reference voltage. A difference between the first threshold and the second threshold may increase corresponding to an increase in the cumulative number of times.

In addition, in accordance with another aspect of the present disclosure, the controller 17 may initialize the cumulative number of times based on the output of the battery 16 being equal to or greater than the reference voltage, and increase the cumulative number of times based on the output of the battery 16 being less than the reference voltage.

In addition, in accordance with another aspect of the present disclosure, the aerosol-generating device 10 may further include a first switching element 1220 electrically connected to a first heater 210 of the plurality of heaters 115, 210, and a second switching element 1230 electrically connected to a second heater 115 of the plurality of heaters 115, 210. The controller 17 may control an operation of each of the first switching element and the second switching element based on the duty ratios corresponding to each of the plurality of heaters 115, 210.

An aerosol-generating device according to an aspect of the present disclosure for accomplishing the above and other objects may include a battery 16, a temperature sensor 950 configured to sense a temperature of the battery 16, a heater 110, and a controller 17. The controller 17 may be configured to determine a threshold for a duty ratio corresponding to an output of the battery 16, based on the temperature of the battery 16, and adjust a duty ratio corresponding to the heater 110 based on the duty ratio corresponding to the heater 110 equal to or greater than the threshold.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
a battery;
a temperature sensor configured to sense a temperature of the battery;
a plurality of heaters; and
a controller configured to:
determine, based on the temperature of the battery, a threshold for a duty ratio corresponding to an output of the battery; and
adjust at least one duty ratio among duty ratios corresponding to the plurality of heaters based on a total duty ratio of the plurality of heaters being greater than or equal to the threshold.

2. The aerosol-generating device according to claim 1, further comprising:
a chamber configured to store a liquid; and
a housing having an elongated insertion space,
wherein the plurality of heaters comprises:
a first heater configured to heat the liquid; and
a second heater configured to heat a stick inserted into the insertion space.

3. The aerosol-generating device according to claim 1, wherein the controller is configured to adjust the at least one duty ratio by decreasing a duty ratio corresponding to a heater having a lowest priority among the plurality of heaters.

4. The aerosol-generating device according to claim 1, wherein the controller is configured to adjust the at least one duty ratio by decreasing the duty ratios corresponding to each of the plurality of heaters based on corresponding priorities of the plurality of heaters, and wherein a first decrement of a duty ratio corresponding to a first heater is greater than a second decrement of a duty ratio corresponding to a second heater based on a priority of the second heater being higher than that of the first heater.

5. The aerosol-generating device according to claim 1, wherein the controller is configured to:
determine a first threshold corresponding to the temperature of the battery, and
determine a second threshold less than or equal to the first threshold as a threshold for the total duty ratio,
wherein the second threshold is determined based on a heating time during which power is supplied to at least one of the plurality of heaters, and
wherein a difference between the first threshold and the second threshold decreases as the heating time increases.

6. The aerosol-generating device according to claim 5, wherein the second threshold is obtained by multiplying the first threshold by a ratio for adjustment corresponding to the heating time,
wherein the ratio for adjustment increases as the heating time increases.

7. The aerosol-generating device according to claim 1, wherein the controller is configured to:
determine a first threshold corresponding to the temperature of the battery, and
determine a second threshold less than or equal to the first threshold as a threshold for the total duty ratio,
wherein the second threshold is determined based on a counter indicating a cumulative number of times an output of the battery is determined to be less than a predetermined reference voltage, and
wherein a difference between the first threshold and the second threshold increases as the counter indicating the cumulative number of times increases.

8. The aerosol-generating device according to claim 7, wherein the controller is configured to:
initialize the counter indicating the cumulative number of times based on the output of the battery being determined to be equal to or greater than the reference voltage, and
increment the counter based on the output of the battery being determined to be less than the reference voltage.

9. The aerosol-generating device according to claim 1, further comprising:
a first switching element electrically connected to a first heater of the plurality of heaters; and
a second switching element electrically connected to a second heater of the plurality of heaters,
wherein the controller is configured to control operation of each of the first switching element and the second switching element based on the duty ratios corresponding to the plurality of heaters.

10. An aerosol-generating device comprising:
a battery;
a temperature sensor configured to sense a temperature of the battery;
a heater; and
a controller configured to:
determine, based on the temperature of the battery, a threshold for a duty ratio corresponding to an output of the battery, and
adjust a duty ratio corresponding to the heater based on the duty ratio corresponding to the heater being equal to or greater than the threshold.
